(19) United States
(12) Patent Application Publication
(10) Pub. No.: US 2025/0289970 A1
(43) Pub. Date: Sep. 18, 2025

(54) Ink Jet Ink Composition

(71) Applicant: SEIKO EPSON CORPORATION, Tokyo (JP)

(72) Inventors: Jun ITO, Shimosuwa (JP); Mitsuaki KOSAKA, Minowa (JP)

(21) Appl. No.: 19/079,974

(22) Filed: Mar. 14, 2025

(30) Foreign Application Priority Data
Mar. 15, 2024 (JP) 2024-040941

(51) Int. Cl. C09D 11/38; C08K 5/19; C08K 5/3412; C09D 11/326

(52) U.S. Cl. CPC C09D 11/38; C08K 5/19; C08K 5/3412; C09D 11/326

(57) ABSTRACT

An ink jet ink composition includes a pigment, a lactam having a 6- to 8-membered lactam ring, a solvent component, and a water-soluble urethane resin dissolved in the solvent component. The pigment contains a self-dispersing pigment having a carboxyl group introduced therein, and the content of the water-soluble urethane resin is 0.38 by mass or more relative to the total amount of the ink jet ink composition. The solvent component contains water, and the ink jet ink composition is an aqueous ink.

The present application is based on, and claims priority from JP Application Serial Number 2024-040941, filed Mar. 15, 2024, the disclosure of which is hereby incorporated by reference herein in its entirety.

### BACKGROUND

### 1. Technical Field

The present disclosure relates to an ink jet ink composition.

### 2. Related Art

An ink jet recording method can record high-definition images by a relatively simple apparatus and is rapidly developed in various fields. In particular, various examinations are performed for improving performance of high-speed printing. For example, JP-A-2020-006556 discloses an ink jet recording apparatus including a line head in which ink-ejecting nozzles formed in a direction intersecting the transport direction of a recording medium are formed so as to cover a printing region of the recording medium in the intersecting direction. The recording apparatus also includes a drying unit which dries the recording medium, a transport unit which transports the recording medium, and a control unit. The ink contains colloidal silica, and the control unit controls the drying unit or the transport unit so that drying of the ink is started within 0.4 seconds after the ink is adhered to the recording medium. Printing using the ink jet recording apparatus disclosed in JP-A-2020-006556 allows recording media to be precisely stacked even by high-speed printing.

An ink is still unsatisfactory in terms of excellent color development, abrasion resistance, and clogging recoverability.

### SUMMARY

According to an aspect of the present disclosure, an ink jet ink composition contains a pigment, a lactam having a 6- to 8-membered lactam ring, a solvent component, and a water-soluble urethane resin dissolved in the solvent component. The pigment contains a self-dispersing pigment having a carboxyl group introduced therein, the content of the water-soluble urethane resin is 0.3% by mass or more relative to the total amount of the ink jet ink composition, and the solvent component contains water, the ink composition being an aqueous ink.

### BRIEF DESCRIPTION OF THE DRAWINGS

FIG. 1 is a schematic view of a recording apparatus used in an embodiment of the present disclosure.

FIG. 2 is a schematic view of a recording apparatus used in an embodiment of the present disclosure.

FIG. 3 is a table showing results of examples.

FIG. 4 is a table showing results of examples.

### DESCRIPTION OF EMBODIMENTS

An embodiment of the present disclosure (referred to as a “present embodiment” hereinafter) is described below, if required, with reference to the drawings, but the present disclosure is not limited to this and various modifications can be made within a range not deviating from the gist of the present disclosure. In addition, in the drawings, the same component is denoted by the same reference numeral, and duplicate description is omitted. Also, the vertical and horizontal positional relationships are based on the positional relationships shown in the drawings unless otherwise specified. Further, the dimensional ratios in the drawings are not limited to the ratios shown in the drawings.

### 1. Ink Jet Ink Composition

An ink jet ink composition of the present embodiment contains a pigment, a lactam having a 6- to 8-membered lactam ring, a solvent component, and a water-soluble urethane resin dissolved in the solvent component. The pigment contains a self-dispersing pigment having a carboxyl group introduced therein, the content of the water-soluble urethane resin is 0.3% by mass or more relative to the total amount of the ink jet ink composition, and the solvent component contains water, the ink composition being an aqueous ink.

When a recorded matter is obtained by recording using an aqueous ink on an absorptive recording medium such as plain paper or the like, the ink preferably has high color development for making it easy to see even a fine-line character. In this respect, a self-dispersing pigment stays on the surface of the recording medium and is hardly permeated into the recording medium due to the reaction of hydrophilic functional groups introduced in the surface of the pigment with the calcium salt contained in the absorptive recording medium such as plain paper or the like, and thus the pigment generally tends to have excellent color development. On the other hand, the self-dispersing pigment, which easily stays on the surface of the recording medium, has low abrasion resistance and thus may be peeled by, for example, rubbing with a line marker for marking. Besides the line-marker resistance, contamination occurs when the ink is transferred by rubbing a recorded portion and transferred to a member such as a printer roller or the like or to another recording medium. The contamination becomes remarkable, particularly, in an ink jet printer such as a line-system business ink jet printer or the like, in which printing is performed at a high speed.

On this point, the ink jet ink composition of the present embodiment contains the self-dispersing pigment having a carboxyl group introduced therein, which has excellent abrasion resistance in addition to excellent color development, and a specific amount of the water-soluble urethane resin dissolved in the solvent component.

Therefore, the water-soluble urethane resin forms a film on the surface of the recording medium after the ink jet ink composition is ejected thereto, and thus the ink jet ink composition is hardly peeled from the recording medium, thereby further improving the abrasion resistance (line-marker resistance) of the recording medium. In addition, the film is easily formed before complete drying of the ink composition, and thus there is a tendency that ink transfer can be suppressed immediately after printing.

In addition, the water-soluble urethane resin hardly produces foreign materials by precipitation or the like even at the gas-liquid interface between the ink jet ink composition and the air. On the other hand, when the ink jet ink composition is allowed to stand for a long time and drying of the solvent component proceeds, foreign materials occur at the gas-liquid interface, or the ink jet ink composition is easily partially solidified. Therefore, when after allowed to stand for a long time, the ink jet ink composition is ejected from an ink jet head, clogging occurs in the ink jet head, and the clogging is hardy eliminated even by head cleaning. That is, it is found that clogging recoverability is deteriorated. The clogging recoverability is considered to be deteriorated due to the poor re-dispersibility of the solid formed by mixing the pigment with the water-soluble urethane resin.

Therefor, the ink jet ink composition of the present embodiment further contains the lactam having a 6 to 8-membered lactam ring. This improves the moisture-retaining property of the ink jet ink composition and makes it hard to dry. As a result, the solvent is hardly dried even when the ink jet ink composition is allowed to stand for a long time, and the solid formed by mixing the pigment with the water-soluble urethane resin is prevented from occurring, thereby causing excellent clogging recoverability. In addition, the ink composition can be prevented from being dried in nozzles of the ink jet head, and thus flying curve and non-ejection of the ink composition can be prevented, and ejection stability tends to be excellent.

Therefore, it is considered that the ink jet ink composition of the present embodiment can satisfy good color development, good abrasion resistance of a recorded matter, and good clogging recoverability.

Each of the components of the ink jet ink composition of the present embodiment is described in detail below. The ink jet ink composition of the present embodiment is simply referred to as the “ink composition” hereinafter.

### 1. 1. Coloring Material

The ink composition of the present embodiment contains the pigment as a coloring material. The content of the pigment relative to the total amount of the ink composition is not particularly limited, but is, for example, preferably 0.5% to 15.0% by mass. Coloring materials may be used alone or in combination of two or more.

### 1. 1. 1. Pigment

The pigment of the present embodiment contains a self-dispersing pigment having a carboxyl group introduced therein. This tends to improve the color development of the ink composition. Also, the self-dispersing pigment tends to have high color development, but recording using the ink composition containing the self-dispersing pigment having a carboxyl group introduced therein tends to improve the abrasion resistance of a recorded matter as compared with when the ink composition containing another self-dispersing pigment is used. In addition, the self-dispersing pigment easily stays on the surface of a recording medium due to interaction between the carboxyl group and a component contained in the recording medium such as plain paper or the like, and thus the color development tends to be improved.

The self-dispersing pigment is a pigment which can dispersed in a solvent such as water or the like without using a dispersant such as a resin or the like. For example, a hydrophilic group such as a carboxyl group or the like bonds to the pigment directly or through another atomic group, and the pigment is dispersed with the hydrophilic group. Examples of the hydrophilic group other than the carboxyl group include, but are particularly not limited to, oxygen-containing hydrophilic groups such as a ketone group, a hydroxyl group, an ester group, a lactone group, an alkylene oxide group, and the like; sulfur-containing hydrophilic groups such as a sulfonic acid group, a sulfinic acid group, and the like; phosphorus-containing hydrophilic groups such as a phosphoric acid group, a phosphonic acid group, and the like; and an amino group. Among these, oxygen-containing hydrophilic groups are preferred.

In the present embodiment, the term “hydrophilic group” includes not only the hydrophilic group but also ions and salts of the hydrophilic group. For example, the carboxyl group includes not only a carboxyl group but also an ion in a state where a hydrogen atom is isolated from the carboxyl group and a salt in a state where another atom such as sodium or the like is bonded in place of a hydrogen atom of the carboxyl group. That is, the carboxyl group may be converted into an ion or a salt.

A method for introducing the carboxyl group into the pigment is not particularly limited but, for example, a carbon atom on the surfaces of pigment particles may be oxidized to a carboxyl group by physical treatment with vacuum plasma or chemical treatment with an oxidizer such as sodium hypochlorite, ozone, or the like, or a carboxyl group may be introduced into the surfaces of pigment particles by treating the pigment particle surfaces with a carboxyl group-containing compound such as a carboxylic acid or salt thereof, such as 4-amino-1, 2-benzene dicarboxylic acid or the like. In this case, the term “treating” includes chemical bonding of the carboxyl group-containing compound to the surfaces of pigment particles and chemical bonding of a carboxyl group-containing compound derived from the carboxyl group-containing compound. The term also includes introducing a carboxyl group produced on the pigment surfaces by oxidation treatment of the pigment.

From the viewpoint of improving the color development of the recording medium, the self-dispersing pigment having a carboxyl group introduced therein is preferably a self-dispersing pigment having a carboxyl group introduced therein by oxidizing a carbon atom on the surfaces of pigment particles.

The ink jet ink composition of the present embodiment may contain a self-dispersing pigment other than the self-dispersing pigment having a carboxyl group introduced therein. For example, a self-dispersing pigment having a phosphonic acid group introduced therein is preferred from the viewpoint of more improving the color development. The self-dispersing pigment having a sulfonic acid group introduced therein is preferred from the viewpoint of more improving the abrasion resistance of a recorded matter. On the other hand, the self-dispersing pigment having a carboxyl group introduced therein is excellent in both the color development and the abrasion resistance of a recorded matter.

Also, the ink composition of the present embodiment may contain a resin-dispersed pigment other than the self-dispersing pigment. The resin-dispersed pigment is a pigment which can be dispersed in a solvent such as water or the like using a resin and is, for example, a pigment with the surfaces coated with a resin. A dispersant described later can be used as the resin for the resin-dispersed pigment. Using the resin-dispersed pigment can improve the abrasion resistance of a recorded matter. While the self-dispersing pigment tends to have higher color development than the resin-dispersed pigment.

Both an inorganic pigment and an organic pigment can be used as the pigment. The pigments may be used alone or in combination of two or more. The term “pigment” herein presents a pigment used as a base for the self-dispersing pigment. The self-dispersing pigment can be obtained by surface treatment of the pigment described herein.

Usable examples of the inorganic pigment include carbon black (C. I. (Color Index Generic Name) Pigment Black 7) such as furnace black, lamp black, acetylene black, channel black, and the like; iron oxide; and titanium oxide. In particular, a black pigment such as carbon black or the like is preferably useful because it can be used for a black ink.

Example of the organic pigment include azo pigments such as an insoluble azo pigment, a condensed azo pigment, an azo lake, a chelate azo pigment, and the like; polycyclic pigments such as a phthalocyanine pigment, perylene and perinone pigments, an anthraquinone pigment, a quinacridone pigment, a dioxane pigment, a thioindigo pigment, an isoindolinone pigment, a quinophthalone pigment, and the like; dye chelates (for example, a basic dye chelate, an acidic dye chelate, and the like), dyeing lakes (a basic dye lake, an acidic dye lake, and the like); a nitro pigment, a nitroso pigment, aniline black, and a daylight fluorescent pigment.

The volume-average particle diameter (D50) of the pigment is preferably 80 to 200 nm or 90 to 150 nm. The volume-average particle diameter can be measured as a D50 value using a particle size distribution analyzer using a laser diffraction-scattering method as a measurement principle. Examples of the particle size distribution analyzer include a particle size analyzer (for example, “Microtrac UPA” manufactured by Nikkiso Co., Ltd.) using a dynamic light scattering method as a measurement principle.

The content of the self-dispersing pigment having a carboxyl group introduced therein relative to the total amount of the ink composition is preferably 0.5% by mass or more or 15% by mass or less, and further preferably 1.0% to 12.0% by mass, more preferably 3.0% to 10.0% by mass, still more preferably 4.0% to 8.0% by mass, and particularly preferably 5.0% to 7.0% by mass. The content relative to the total amount of the ink composition may be preferably 3% to 12% by mass.

When the content of the self-dispersing pigment having a carboxyl group introduced therein is within the range described above, the color development and abrasion resistance tend to be more improved.

The content of the pigment relative to the total amount of the ink composition is not particularly limited but is, for example, 3.0% to 12.0% by mass.

The content of the self-dispersing pigment having a carboxyl group introduced therein relative to the total amount of the pigment is not particularly limited but is, for example, 80% to 100% by mass, 90% to 100% by mass, or 95% to 100% by mass.

### 1. 1. 2. Dispersant

When the ink composition of the present embodiment contains the resin-dispersed pigment, the ink composition may contain a dispersant for dispersing the pigment. The dispersant is present near the surfaces of pigment particles so as to surround the surfaces. For example, the dispersant is adsorbed or adhered to the pigment.

In this respect, the dispersant is different from a water-soluble resin and resin particles described later. In the present embodiment, the dispersant for dispersing the pigment is not included in resins described later.

Unlike the resins described later, the dispersant functioning by adhesion to the pigment hardly contributes to the formation of a film. The dispersants may be used alone or in combination of two or more.

The dispersant is not particularly limited, but is, for example, a dispersant such as a polymer dispersant or the like, which is commonly used for preparing a pigment dispersion liquid. Specific examples thereof include a dispersant containing, as a main component, one or more of polyoxyalkylene polyalkylene polyamine, vinyl-based polymer and copolymer, acrylic polymer and copolymer, polyester, polyamide, polyimide, polyurethane, an amino-based polymer, silicon-containing polymer, sulfur-containing polymer, fluorine-containing polymer, and an epoxy resin.

Examples of a commercial product of the polymer dispersant include Ajisper series manufactured by Ajinomoto Fine Techno Co., Ltd., Solsperse series (Solsperse 36000 and the like) available from Avecia, Inc. and Noveon, Inc., Disper BYK series manufactured by BYK Additives & Instruments Corporation, Disparlon series manufactured by Kusumoto Chemicals, Ltd.

The content of the dispersant relative to the total amount of the ink composition is not particularly limited but is, for example, 0.1% to 5.0% by mass.

### 1. 2. Resin

The ink composition of the present embodiment contains 0.3% by mass or more of the water-soluble urethane resin relative to the total amount of the ink composition. This tends to improve the abrasion resistance of a recorded matter obtained from the ink composition of the present embodiment and to suppress ink transfer. Also, the water-soluble resin tends to hardly produce foreign materials by precipitation or the like at the gas-liquid interface between the ink jet ink composition and air and to more improve ejection stability. The water-soluble urethane resin includes a resin in a state of being dissolved in the solvent component described later. The water-soluble urethane resin may not be in a state of being entirely dissolved in the solvent, but is preferably in a state where 90% by mass or more of the resin is dissolved in the solvent component. Further, the resin is more preferably in a state where the whole is dissolved in the solvent component.

Exampled of the resin contained in the ink composition of the present embodiment include, besides the water-soluble urethane resin, water-soluble resins other than the water-soluble urethane resin, resin particles, and the like. The resins may be used alone or in combination of two or more.

The content of the resin relative to the total amount of the ink composition is preferably 0.3% to 3.0% by mass, 0.4% to 2.5% by mass, 0.4% to 2.0% by mass, 0.4% to 1.5% by mass, or 0.4% to 1.0% by mass. The content of the resin within the range described above tends to improve the abrasion resistance of a recorded matter.

1. 2. 1. Water-soluble resin
1. 2. 1. 1. Water-soluble urethane resin

The water-soluble urethane resin represents a water-soluble urethane resin having a polar group in its molecular structure. The polar group may be in a salt state. Also, the polar group is preferably an acid group. Example of the acid group include a carboxyl group, a sulfonic acid group, a phosphorus-containing group such as a phosphoric acid group, and the like. The water-soluble urethane resins may be used alone or in combination of two or more.

The water-soluble urethane resin has a N—H bond in its structure. It is considered that due to the N—H bond, a hydrogen bond is produced in a film of the water-soluble urethane resin and thus the film is more strongly formed, and consequently the recorded matter tends to have excellent abrasion resistance.

Also, it is supposed that a film is easily formed on the ink surface even before the ink adhered to the recording medium is sufficiently dried, thereby exhibiting excellent abrasion resistance and excellent suppression of ink contamination. On the other hand, particularly when drying of the ink proceeds, which contains the self-dispersing pigment having a carboxyl group introduced therein and the water-soluble urethane resin, clogging recoverability becomes a problem. It is supposed that when drying of the ink proceeds, a strong solid is formed between the pigment and the water-soluble urethane resin.

In the present embodiment, the “water-soluble resin” is a resin having water solubility that represents being soluble in water. The state of having “water solubility” can be recognized by mixing and stirring 1% by mass of the resin in water at room temperature (25° C.) and then observing that the whole of the liquid does not look cloudy with no remainder after dissolution.

In addition, the resin can be preferably present in a state not having a particle diameter when measured by a dynamic light scattering method.

The water-soluble urethane resin has repeating units derived from polyisocyanate and polyol, and preferably has a repeating unit derived from a polyol having an acid group and preferably a resin having a repeating unit derived from each of polyisocyanate, a polyol not having an acid group, and a polyol having an acid group. The water-soluble urethane resin may further a repeating unit derived from a polyamine.

The term “polyisocyanate” represents a compound having two or more isocyanate groups in its molecular structure, and examples thereof include, but are not particularly limited to, an aliphatic polyisocyanate, an aromatic polyisocyanate, and the like.

Examples of the aliphatic polyisocyanate include, but are not particularly limited to, polyisocyanates having a chain-like structure, such as tetramethylene diisocyanate, dodecamethylene diisocyanate, hexamethylene diisocyanate, 2,2, 4-trimethylhexamethylene diisocyanate, 2, 4, 4-trimethylhexamethylene diisocyanate, lysine diisocyanate, 2-methylpentane-1, 5-diisocyanate, 3-methylpentane-1, 5-diisocyanate, and the like; polyisocyanates having a cyclic structure, such as isophorone diisocyanate, hydrogenated xylylene diisocyanate, 4,4′-dicyclohexylmethane diisocyanate, 1,4-cyclohexane diisocyanate, methylcyclohexylene diisocyanate, 1,3-bis(isocyanatomethyl)cyclohexane, and the like.

Examples of the aromatic polyisocyanate include, but are not particularly limited to, tolylene diisocyanate, 2, 2′-diphenylmethane diisocyanate, 2, 4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate, α, α, α′, α′-tetramethylxylylene diisocyanate, and the like.

The polyol is a compound having two or more hydroxyl groups in its molecular structure. Examples of the polyol of the present embodiment include, but are not particularly limited to, a polyol not having an acid group and a polyol having an acid group.

Examples of the polyol not having an acid group include, but are not particularly limited to, polyether polyol, polyester polyol, polycarbonate polyol, and the like.

Examples of polyether polyol include, but are not particularly limited to, addition polymers of alkylene oxide and polyols, glycols, and the like.

Examples of alkylene oxide include, but are not particularly limited to, ethylene oxide, propylene oxide, butylene oxide, α-olefine oxide, and the like. Examples of polyols to be addition-polymerized with alkylene oxide include diols such as 1, 3-propanediol, 1,3-butanediol, 1,4-butanediol, 1,5-pentanediol, 1,6-hexanediol, 3-methyl-1, 5-pentanediol, 2-butyl-2-ethyl-1, 3-propanediol, 1, 4-cyclohexanediol, 1,4-cyclohexane dimethanol, 4,4-dihyroxyphenylpropane, 4,4-dihydroxyphenylmethane, hydrogenated bisphenol A, dimethylol urea and derivatives thereof, and the like; triols such as glycerin, trimethylol propane, 1, 2, 5-hexanetriol, 1, 2, 6-hexanetriol, pentaerythritol, trimethylol melamine and derivatives thereof, polyoxypropylene triol, and the like; and the like.

Examples of glycols include (poly)alkylene glycols such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, (poly)tetramethylene glycol, and the like; ethylene glycol-propylene glycol copolymer; and the like.

Examples of polyester polyol include, but are not particularly limited to, an acid ester and the like. Examples of an acid component constituting an acid ester include, but are not particularly limited to, aromatic dicarboxylic acids such as phthalic acid, naphthalene dicarboxylic acid, biphenyl dicarboxylic acid, tetrahydrophthalic acid, and the like; alicyclic dicarboxylic acids such as hydrogenated products of these aromatic dicarboxylic acids and the like; aliphatic dicarboxylic acids such as malonic acid, succinic acid, tartaric acid, oxalic acid, glutaric acid, adipic acid, pimelic acid, suberic acid, azelaic acid, sebacic acid, alkyl succinic acid, linolenic acid, maleic acid, fumaric acid, mesaconic acid, citraconic acid, itaconic acid, and the like; and the like. Also, anhydrides, salts, derivatives (alkyl esters and alkyl halides), and the like of these acids can be used as the acid component. Examples of a component which forms an ester with the acid component include, but are not particularly limited to, polyols such as diol, triol, and the like; glycols such as (poly)alkylene glycol and the like; and the like. Examples of polyols and glycols include those exemplified as the component constituting the polyester polyol described above.

The polycarbonate polyol is not particularly limited, but for example, polycarbonate polyol produced by a known method can be used. Specific examples thereof include alkanediol-based polycarbonate diol such as polyhexamethylene carbonate diol and the like, and the like. The examples also include polycarbonate diol produced by reacting a carbonate component, such as alkylene carbonate, diallyl carbonate, dialkyl carbonate, or the like and phosgene with an aliphatic diol component, and the like.

Examples of the polyol having an acid group include, but are not particularly limited to, polyols having an acid group such as a carboxylic acid group, a sulfonic acid group, a phosphoric acid group, a phosphonic acid group, or the like. Among these, one or more of a carboxylic acid group, a sulfonic acid group, a phosphorus-containing group such as a phosphoric acid group, or the like are preferred, and a carboxylic acid group is more preferred.

Examples of the polyol having a carboxylic acid group include, but are not particularly limited to, dimethylolacetic acid, dimethylolpropionic acid, dimethylolbutanoic acid, dimethylolbutyric acid, and the like.

The acid group of the polyol having an acid group may be in a salt state. Examples of a cation which forms the salt include, but are not particularly limited to, an alkali metal ion, an organic amine cation, and the like. Examples of the alkali metal ion include, but are not particularly limited to, lithium, sodium, potassium, and the like. Examples of the organic amine cation include, but are not particularly limited to, ammonium ion, dimethylamine, and the like.

Examples of polyamine include, but are not particularly limited to, monoamines having a plurality of hydroxy groups, such as dimethylolethyl amine, diethanolmethyl amine, dipropanolethyl amine, dibutanolmethyl amine, and the like; difunctional polyamines such as ethylenediamine, propylene diamine, hexylene diamine, isophorone diamine, xylylene diamine, diphenylmethane diamine, hydrogenated diphenylmethane diamine, hydrazine, and the like; tri- or higher-functional polyamines such as diethylene triamine, triethylene tetramine, tetraethylene pentamine, polyamide-polyamine, polyethylene polyimine, and the like; and the like.

The acid value of the water-soluble urethane resin is preferably 40 to 80 mgKOH/g, 45 to 80 mgKOH/g, or 50 to 80 mgKOH/g. The acid value of the urethane resin within the range described above tends to exhibit more excellent abrasion resistance, ejection stability, and clogging recoverability. The acid value of the water-soluble urethane resin is not particularly limited, but can be adjusted by, for example, the use amount of polyol having an acid group. Also, a method for measuring the acid value may be a potentiometric titration method. For example, the method of examples described later can be used.

The weight-average molecular weight of the water-soluble urethane resin is preferably 5000 to 150000, 7500 to 100000, 10000 to 50000, 12500 to 30000, or 15000 to 25000. The weight-average molecular weight within the range described above tends to more improve ejection stability. The weight-average molecular weight of the water-soluble urethane resin is not particularly limited, but can be adjusted by, for example, the reaction temperature, reaction time, or the like of polyisocyanate and polyol. Also, a method for measuring the weight-average molecular weight may be a method using a GPC method. For example, the method of examples described later can be used.

The number-average molecular weight of the water-soluble urethane resin is preferably 2000 to 7000 and more preferably 3500 to 5000. The number-average molecular weight within the range described above tends to more improve ejection stability. The number-average molecular weight of the water-soluble urethane resin is not particularly limited, but can be adjusted by, for example, the reaction temperature, reaction time, or the like of polyisocyanate and polyol. Also, the method of examples described later can be used as a method for measuring the number-average molecular weight.

The content of the water-soluble urethane resin relative to the total amount of the ink composition is 0.3% by mass or more, preferably 0.3% to 3.0% by mass, more preferably 0.4% to 2.5% by mass, still more preferably 0.4% to 2.0% by mass, even still more preferably 0.4% to 1.5% by mass, still more preferably 0.4% to 1.0% by mass, and particularly preferably 0.4% to 0.8% by mass or 0.5% to 0.7% by mass.

The resin content within the range described above tends to more improve clogging recoverability, ejection stability, and abrasion resistance of a recorded matter.

### 1. 2. 1. 2. Other Water-Soluble Resin

The ink composition of the present embodiment may or may not contain another water-soluble resin other than the water-soluble urethane resin. Example of the other water-soluble resin include, but are not particularly limited to, a water-soluble acrylic resin, a water-soluble polyester resin, a water-soluble amino resin, and the like. The other resins may be used alone or in combination of two or more.

The content of the other resin relative to the total amount of the ink composition is not particularly limited, but is, for example, 2.0% by mass or less, preferably 1.0% by mass or less, and more preferably 0.5% by mass or less.

### 1. 2. 2. Resin Particle

The ink composition of the present embodiment may or may not contain resin particles. The resin particles are not particles of the water-soluble resin but are particles of a resin dispersed in the solvent component of the ink composition. For example, a resin emulsion or the like can be used.

Examples of the resin particles include, but are not particularly limited to, resin particles composed of a urethane-based resin, an acrylic resin, a fluorene-based resin, a polyolefin-based resin, a rosin-modified resin, a terpen-based resin, a polyester-based resin, a polyamide-based resin, an epoxy-based resin, a vinyl chloride-based resin, ethylene-vinyl acetate-based resin, or the like. From the viewpoint of intermittency and clogging recoverability, the resin particles in an emulsion form are preferably used. These types of resin particles may be used alone or in combination of two or more.

The urethane-based resin is the general term for resins having a urethane bond, and examples thereof include, but are not particularly limited to, a polyether-type urethane resin having an ether bond contained in the main chain thereof, a polyester-type urethane resin having an ester bond contained in the main chain thereof, and a polycarbonate-type urethane resin having a carbonate bond contained in the main chain thereof. The urethane-based resin may be a product prepared by a known method or a commercial product.

The acrylic resin is the general term for polymers produced by polymerizing at least an acrylic monomer such as (meth)acrylic acid, a (meth)acrylate ester, or the like as one component. Examples of the acrylic resin include, but are not particularly limited to, a resin produced by polymerizing a (meth)acrylic monomer such as (meth)acrylic acid, a (meth)acrylate ester, or the like, and a resin such as a styrene-acrylic resin or the like, produced by copolymerizing a (meth)acrylic monomer with another monomer. The acrylic resin may be a product prepared by a known method or a commercial product.

The content of the resin particles relative to the total amount of the ink composition is not particularly limited, but is, for example, preferably 1.0% by mass or less, more preferably 0.5% by mass or less, still more preferably 0.1% by mass or less, and particularly preferably 0.05% by mass or less, and the content may be 0% by mass (not containing the resin particles). The content of the resin particles within the range described above is preferred because of more excellent clogging recoverability and ejection stability.

### 1. 3. Lactam

The ink composition of the present embodiment contains a lactam having a 6- to 8-membered lactam ring.

The lactam represents a compound having a structure in which a ring is formed by intramolecular dehydration condensation of a carboxyl group and amino group. The lactam ring represents a ring formed by intramolecular dehydration condensation of a carboxyl group and amino group. In addition, the term “6- to 8-membered lactam ring” represents that the number of atoms constituting a lactam ring is 6 to 8, and the number includes an atom such as a nitrogen atom and like other than a carbon atom.

Also, when the ink composition of the present embodiment contains an acetylene glycol-based surfactant described later in addition to the lactam having a 6- to 8-membered lactam ring, the lactam makes the ink composition hard to dry and maintains a wet state, and thus the occurrence of foreign materials can be prevented by phase-separation of the acetylene glycol-based surfactant. As a result, the ink composition tends to have excellent ejection stability.

Examples of the lactam having a 6- to 8-membered lactam ring include, but are not particularly limited to, 2-piperidone which may or may not have a substituent, ε-caprolactam which may or may not have a substituent, and ω-heptalactam which may or may not have a substituent. Examples of the substituent include an alkyl group, an alkynyl group, an alkenyl group, a halogen atom, an imino group, an amino group, a thiol group, a hydroxy group, an acyl group, a nitrile group, a formyl group, an amide group, an acryl halide group (—CH₂CH₂—C(═O)—X; X is a halogen atom), an ester group, a carboxyl group, an alkoxy group, a thioalkoxy group, a nitro group, a nitroso group, and the like. The lactams having a 6- to 8-membered lactam ring may be used alone or in combination of two or more.

The content of the lactam having a 6- to 8-membered lactam ring relative to the total amount of the ink composition is preferably 0.1% by mass or more or 6.0% by mass or less.

Further, the content is preferably 0.5% to 5.0% by mass, more preferably 1.0% to 4.0% by mass, still more preferably 1.1% to 3.5% by mass, and particularly preferably 1.2% to 3.0% by mass. When the content of the lactam having a 6- to 8-membered lactam ring is within the range described above, ejection stability and clogging recoverability tend to become more excellent.

In particular, when the content of the lactam having a 6- to 8-membered lactam ring is within or lower than the range described above, ejection stability and clogging recoverability can be suppressed from being decreased by an excessive amount of the lactam having a 6 to 8-membered lactam ring.

### 1. 4. Surfactant

The ink composition of the present embodiment may contain the surfactant. Examples of the surfactant include, but are not particularly limited to, an acetylene glycol-based surfactant, a silicone-based surfactant, and a fluorine-based surfactant. The surfactants may be used alone or in combination of two or more.

The content of the surfactant relative to the total amount of the ink composition is preferably 0.1% to 3.0% by mass or 0.2% to 2.0% by mass. The content of the surfactant within the range described above tends to more improve the ejection stability of the ink composition.

### 1. 4. 1. Acetylene Glycol-Based Surfactant

The ink composition of the present embodiment preferably contains the acetylene glycol-based surfactant. The acetylene glycol-based surfactant tends to decrease the surface tension of the ink composition and thus improve the ejection stability of the ink composition. On the other hand, the acetylene glycol-based surfactant has relatively low solubility in water, and thus when drying of the ink composition proceeds, foreign materials tend to easily occur due to the phase separation of the acetylene glycol-based surfactant.

Examples of the acetylene glycol-based surfactant include an acetylene glycol-based surfactant having a HLB value of 6 or less, and an acetylene glycol-based surfactant having a HLB value of more than 6. In this case, the HLB value is a value indicating the balance between hydrophobicity and hydrophilicity of the surfactant, and the smaller HLB value indicates higher hydrophobicity, and the larger HLB value indicates higher hydrophilicity. In the present disclosure, the HLB value is calculated by a griffin method.

The content of the acetylene glycol-based surfactant relative to the total amount of the ink composition is preferably 0.1% to 2.5% by mass, 0.2% to 2.0% by mass, 0.3% to 1.8% by mass, 0.4% to 1.6% by mass, or 0.5% to 1.4% by mass. Further, the content is preferably 0.6% to 1.0% by mass and more preferably 0.7% to 0.8% by mass.

When the content of the acetylene glycol-based surfactant is within the range described above, the ejection stability of the ink composition tends to be more improved.

### 1. 4. 1. 1. Acetylene Glycol-Based Surfactant Having HLB Value of 6 or Less

The ink composition of the present embodiment preferably contains the acetylene glycol-based surfactant having a HLB value of 6 or less. This tends to particularly improve the ejection stability of the ink composition. The reason for this is considered that the acetylene glycol-based surfactant having a HLB value of 6 or less can decrease the surface tension of the ink jet ink composition and thus making fine ink droplets during ejection, and flying curve of the ink or the like hardly occurs. Further, the permeability of the ink composition into a recording medium tends to be improved. The higher permeability is preferred because when the recording medium, to which the ink composition adheres, comes into contact with another recording medium or a member of a recording apparatus, the possibility of contamination of it is decreased.

The acetylene glycol-based surfactant tends to improve the permeability of the ink composition to a recording medium, and the tendency is remarkable in the case of the acetylene glycol-based surfactant having a HLB value of 6 or less. When the ink composition is excessively permeated into a recording medium, the color development of the recorded matter tends to be decreased. On the other hand, the self-dispersing pigment having a carboxyl group introduced therein and contained in the ink composition of the present embodiment has high color development and suppresses the excessive permeation of the ink composition into the recording medium. Therefore, even when the ink composition of the present embodiment contains the acetylene glycol-based surfactant, both the good permeability of the ink composition to the recording medium and the good color development of a recorded matter can be satisfied.

The acetylene glycol-based surfactant has low solubility in water, and the acetylene glycol-based surfactant having a HLB value of 6 or less has particularly low solubility in water. Thus, when drying of the ink composition proceeds, foreign materials easily occur due to the phase separation of the acetylene glycol-based surfactant, and the ejection stability and clogging recoverability of the ink composition tend to deteriorate.

In this respect, the ink composition of the present embodiment contains the lactam having a 6- or 8-membered lactam ring and thus the ink composition is hardly dried and maintains a wet state. Therefore, even when the ink composition of the present embodiment contains the acetylene glycol-based surfactant, drying of the ink composition hardly proceeds, and the ejection stability of the ink composition and clogging recoverability can be suppressed from deteriorating due to the acetylene glycol-based surfactant.

From this viewpoint, the ratio (mass ratio) of the content of the lactam to the content of the acetylene glycol-based surfactant is preferably 0.5 to 8.0, 1.0 to 7.0, 1.5 to 6.0, or 2.0 to 5.0, and more preferably 2.5 to 4.0.

When the ratio of the content of the lactam to the content of the acetylene glycol-based surfactant is within the range described above, the ejection stability and clogging recoverability tend to be excellent.

Also, the ratio (mass ratio) of the content of the lactam to the content of the acetylene glycol-based surfactant having a HLB value of 6 or less is preferably 1.0 to 25.0, 2.0 to 20.0, 2.5 to 17.5, or 5.0 to 15.0. When the ratio of the content of the lactam to the content of the acetylene glycol-based surfactant having a HLB value of 6 or less is within the range described above, the ejection stability and clogging recoverability tend to be excellent.

Also, the ink composition of the present embodiment contains the water-soluble urethane resin. The water-soluble urethane resin has high compatibility with the acetylene glycol-based surfactant, and thus even when drying of the ink composition proceeds, the occurrence of foreign materials due to phase separation of the acetylene glycol-based surfactant can be suppressed by containing the water-soluble urethane resin. As a result, even when the ink composition of the present embodiment contains the acetylene glycol-based surfactant, the ejection stability and clogging recoverability of the ink composition can be suppressed from deteriorating due to the acetylene glycol-based surfactant.

From this viewpoint, the ratio (mass ratio) of the content of the water-soluble urethane resin to the content of the acetylene glycol-based surfactant is preferably 0.1 to 5.0, 0.1 to 4.0, 0.2 to 3.0, or 0.3 to 2.0. When the ratio of the content of the water-soluble urethane resin to the content of the acetylene glycol-based surfactant is within the range described above, the ejection stability and clogging recoverability tend to be excellent.

Also, the ratio (mass ratio) of the content of the water-soluble urethane resin to the content of the acetylene glycol-based surfactant having a HLB value of 6 or less is preferably 0.5 to 10.0, 1.0 to 7.5, or 1.5 to 5.0. When the ratio of the content of the water-soluble urethane resin to the content of the acetylene glycol-based surfactant having a HLB value of 6 or less is within the range described above, the ejection stability and clogging recoverability tend to be excellent.

The HLB value of the acetylene glycol-based surfactant is preferably 6 or less, 5 or less, or 4 or less. The lower limit of the HLB value is preferably 0 or more, 1 or more, or 2 or more. The HLB value within the range described above tends to cause less phase separation and more improve the ejection stability. The lower limit value and the upper limit value can be arbitrarily combined to form a preferred numerical range. For example, the preferred numerical range of the HLB value of the acetylene glycol-based surfactant may be 0 to 6, 1 to 6, 2 to 6, 0 to 5, 1 to 5, 2 to 5, 0 to 4, 1 to 4, or 2 to 4.

Examples of the acetylene glycol-based surfactant having a HLB value of 6 or less include, but are not particularly limited to, acetylene glycol represented by formula (1) below and an acetylene glycol alkylene oxide adduct represented by formula (2) below. The use of such an acetylene glycol-based surfactant tends to more improve ejection stability and permeability. The acetylene glycol-based surfactants having a HLB value of 6 or less may be used alone or in combination of two or more.

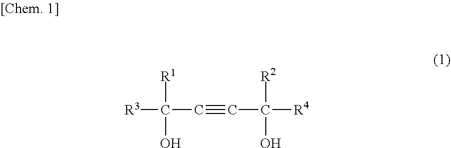

In the formula, R to R: each independently represent an alkyl group having 1 to 4 carbon atoms, which may have a substituent.

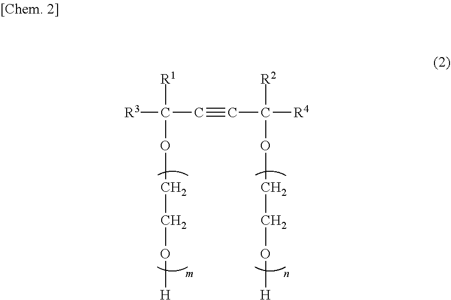

In the formula, R¹ to R⁴ each independently represent an alkyl group having 1 to 4 carbon atoms, which may have a substituent, and m and n each independently represent 0 or an integer of 1 or more and satisfy m+n=1 to 30.

In addition, m is preferably 1 to 15, 1 to 10, or 1 to 5, and n is preferably 1 to 15, 1 to 10, or 1 to 5.

Examples of each of R¹ to R⁴ include, but are not particularly limited to, methyl, ethyl, n-propyl, iso-propyl, n-butyl, sec-butyl, and tert-butyl. In addition, examples of the substituent include an alkyl group, an alkynyl group, an alkenyl group, a halogen atom, an imino group, an amino group, a thiol group, a hydroxy group, an acyl group, a nitrile group, a formyl group, an amide group, a acryl halide group (—CH₂CH₂—C(═O)—X; X is a halogen atom), an ester group, a carboxy group, an alkoxy group, a thioalkoxy group, a nitro group, a nitroso group, and the like.

Examples of the specific structure of the acetylene glycol-based surfactant having a HLB value of 6 or less include a compound represented by the formula (1) and a compound represented by the formula (2), and in the compound represented by the formula (2), n and m are each preferably within or lower than the range described above and 15 or less, 9 or less, or 8 or less. Examples thereof include, but are not particularly limited to, 2, 4, 7, 9-tetramethyl-5-decyne-4, 7-diol and an alkylene oxide adduct thereof. In the adduct, the numbers (n and m) of moles added are each within or lower than the range described above and 15 or less, 9 or less, or 8 or less.

Examples of a product name of the acetylene glycol-based surfactant having a HLB value of 6 or less include Olfine D-10PG (manufactured by Air Products, Inc.), Surfynol 420 and Surfynol 104PG50 (manufactured by Nissin Chemical Industry Co., Ltd.), and the like.

The content of the acetylene glycol-based surfactant having a HLB value of 6 or less relative to the total amount of the ink composition is preferably 0.1% to 1.0% by mass, 0.1% to 0.8% by mass, 0.1% to 0.6% by mass, 0.1% to 0.4% by mass, or 0.1% to 0.3% by mass. When the content of the acetylene glycol-based surfactant having a HLB value of 6 or less is within the range described above, the ejection stability tends to be more improved.

The content of the acetylene glycol-based surfactant having a HLB value of 6 or less relative to the total amount of the surfactant is preferably 10% to 60% by mass, 15% to 50% by mass, 20% to 40% by mass, or 20% to 35% by mass. When the content of the acetylene glycol-based surfactant having a HLB value of 6 or less is within the range described above, the ejection stability tends to be more improved.

The content of the acetylene glycol-based surfactant having a HLB value of 6 or less relative to the total amount of the acetylene glycol-based surfactant is preferably 10% to 60% by mass, 15% to 50% by mass, 20% to 40% by mass, or 20% to 35% by mass. When the content of the acetylene glycol-based surfactant having a HLB value of 6 or less is within the range described above, the ejection stability tends to be more improved.

1. 4. 1. 2. Acetylene Glycol-Based Surfactant Having HLB Value of More than 6

The ink composition of the present embodiment may contain an acetylene glycol-based surfactant having a HLB value of more than 6. Among acetylene glycol-based surfactants, that having a HLB value of more than 6 has a relatively small tendency to improve ink permeability as compared with that having a HLB value of 6 or less while having a small tendency to cause phase separation in the ink composition.

Therefore, when the acetylene glycol-based surfactant having a HLB value of more than 6 is contained together with the acetylene glycol-based surfactant having a HLB value of 6 or less, the permeability of the ink composition to the recording medium is more improved, and thus the non-permeated ink composition hardly remains. This can suppress contamination of a transport passage with the non-permeated ink composition, transfer of the contamination of the transport passage to another recording medium, and decrease in transportability. Also, when the acetylene glycol-based surfactant having a HLB value of more than 6 is used in combination of the acetylene glycol-based surfactant having a HLB value of 6 or less, there is a tendency that the ejection stability can be improved. Further, when the acetylene glycol-based surfactant having a large HLB value is present, compatibility with water of the acetylene glycol-based surfactant having a small HLB value is preferably improved.

The HLB value of the acetylene glycol-based surfactant is preferably 6 or more, 7 or more, or 8 or more. The upper limit of the HLB value is preferably 14 or less, 13 or less, or 12 or less. The HLB value within the range described above tends to cause less phase separation and more improve the ejection stability. The lower limit value and the upper limit value can be arbitrarily combined to form a preferred numerical range. For example, the preferred numerical range of the HLB value of the acetylene glycol-based surfactant may be over 6 and 14 or less, over 6 and 13 or less, over 6 and 13 or less, over 6 and 12 or less, 7 to 14, 7 to 13, 7 to 12, 8 to 14, 8 to 13, or 8 to 12.

Examples of the specific structure of the acetylene glycol-based surfactant having a HLB value of more than 6 include, but are not particularly limited to, 5, 8-dimethyl-6-dodecyne-5, 8-diol and alkylene oxide adducts thereof, 4,7-dimethyl-5-decyne-4, 7-diol and alkylene oxide adducts thereof, alkylene oxide adducts of 2, 4, 7, 9-tetramethyl-5-decyne-4, 7-diol, any one or each of the numbers of moles added of the adducts being 9 or more, 10 or more, or 16 or more. The examples also include the compound represented by the formula (2), in which any one or each of the numbers (n and m) of moles added of the adduct is 9 or more, 10 or more, or 16 or more. The acetylene glycol-based surfactants having a HLB value of more than 6 may be used alone or in combination of two or more.

Examples of a product name of the acetylene glycol-based surfactant having a HLB value of more than 6 include Olfine E1010 (manufactured by Nissin Chemical Industry Co., Ltd.) and the like.

The content of the acetylene glycol-based surfactant having a HLB value of more than 6 relative to the total amount of the ink composition is preferably 0.1% to 1.5% by mass, 0.2% to 1.0% by mass, or 0.2% to 0.8% by mass. When the content of the acetylene glycol-based surfactant having a HLB value of more than 6 is within the range described above, the ejection stability tends to be more improved.

The content of the acetylene glycol-based surfactant having a HLB value of more than 6 relative to the total amount of the surfactant is preferably 40% to 85% by mass, 45% to 80% by mass, or 50% to 80% by mass. When the content of the acetylene glycol-based surfactant having a HLB value of more than 6 is within the range described above, the ejection stability tends to be more improved. The content of the acetylene glycol-based

surfactant having a HLB value of more than 6 relative to the total amount of the acetylene glycol-based surfactant is preferably 40% to 85% by mass, 45% to 80% by mass, or 50% to 80% by mass. When the content of the acetylene glycol-based surfactant having a HLB value of more than 6 or less is within the range described above, the ejection stability tends to be more improved.

### 1. 4. 2. Silicone-Based Surfactant

The ink composition of the present embodiment may or may not contain a silicone-based surfactant. The silicone-based surfactant tends to be easily foamed and adversely affect the ejection stability. Also, the silicone-based surfactant has low compatibility with the water-soluble urethane resin, and thus the phase separation of the silicone-based surfactant is not suppressed by the water-soluble urethane resin. Therefore, the ink composition preferably does not contain the silicone-based surfactant. Examples of the silicone-based surfactant include a polysiloxane-based compound, a polyether-modified organosiloxane, and the like. Examples of a commercial product of the silicone-based surfactant include, but are not particularly limited to, BYK-306, BYK-307, BYK-333, BYK-341, BYK-345, BYK-346, BYK-347, BYK-348, BYK-349, and BYK-UV3500 (the above product names, manufactured by BYK Chemie Japan K. K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (the above product manes, manufactured by Shin-Etsu Chemical Co., Ltd.), and the like.

The content of the silicone-based surfactant relative to the total amount of the ink composition is not particularly limited, but is, for example, 2.0% by mass or less and 0.1% to 2.0% by mass.

### 1. 4. 3. Fluorine-Based Surfactant

The ink composition of the present embodiment may or may not contain a fluorine-based surfactant. Examples of the fluorine-based surfactant include, but are not particularly limited to, perfluoroalkyl sulfonate salts, perfluoroalkyl carboxylate salts, perfluoroalkyl phosphate esters, perfluoroalkyl ethylene oxide adducts, perfluoroalkyl betaine, and perfluoroalkyl amine oxide compounds. Examples of a commercial product of the fluorine-based surfactant include, but are not particularly limited to, S-144 and S-145 (manufactured by AGC Inc.); FC-170C, FC-430, and Fluorad-FC4430 (manufactured by Sumitomo 3M Ltd.); FSO, FSO-100, FSN, FSN-100, and FS-300 (manufactured by Dupont Inc.); FT-250 and 251 (manufactured by Neos Co., Ltd.); and the like.

The content of the fluorine-based surfactant relative to the total amount of the ink composition is not particularly limited, but is, for example, 2.0% by mass or less and 0.1% to 2.0% by mass.

### 1. 5. Solvent Component

At least water is contained as the solvent component, and an organic solvent may be further contained.

### 1. 5. 1. Organic Solvent

The ink composition of the present embodiment may contain an organic solvent. Examples of the organic solvent include, but are not particularly limited to, monohydric alcohols, polyols, glycol ethers, and the like. The organic solvents may be used alone or in combination of two or more. A water-soluble organic solvent is preferred.

Examples of monohydric alcohols include, but are not particularly limited to, methanol, ethanol, 1-propanol, isopropanol, 1-butanol, 2-butanol, isobutanol, 2-methyl-2-propanol, and the like.

Examples of polyols include alkanediols having 5 or more carbon atoms, such as 1, 2-hexanediol and the like. These can preferably enhance the permeability and ejection stability of the ink. Also, these have the function of increasing the water solubility of the acetylene glycol-based surfactant, increasing the water solubility of, particularly, the acetylene glycol-based surfactant having a HLB value of 6 or less, and suppressing phase separation. Therefore, from the viewpoint of improving the ejection stability, the ink composition preferably contains alkanediol having 5 or more carbon atoms. The alkanediol having 5 or more carbon atoms is more preferably alkanediol having 5 to 10 carbon atoms.

Other examples of the polyols include alkanediol having 4 or less carbon atoms, polyol having 3 or more hydroxyl groups in the molecule thereof, polyol (intermolecular condensate of alkanediol) having an ether group in the molecular skeleton thereof, and the like. The polyols preferably enhance the moisture-retaining property of the ink and improve the ejection stability and clogging recoverability.

Examples of the polyols include, but are not particularly limited to, ethylene glycol, diethylene glycol, triethylene glycol, tetraethylene glycol, pentaethylene glycol, propylene glycol, dipropylene glycol, tripropylene glycol, tetrapropylene glycol, 1,3-propanediol, 1,2-butanediol, 1,2-pentanediol, 1, 2-hexanediol, 1,4-butanediol, 1, 5-pentaanediol, 1,6-hexanediol, glycerin, and the like. Glycol ethers each have 1 or 0 hydroxyl group in its molecule, which is produced by etherification of one or two of the two hydroxyl groups possessed by alkane diol. The etherification is preferably alkyl etherification. Example thereof include glycol monoether, glycol diether, and the like, and glycol monoether is preferred.

Examples of the glycol ethers include, but are not particularly limited to, triethylene glycol monomethyl ether, triethylene glycol dimethyl ether, triethylene glycol monobutyl ether, diethylene glycol monobutyl ether, dipropylene glycol monopropyl ether, tetraethylene glycol monobutyl ether, tetraethylene glycol monooctyl ether, triethylene glycol monohexyl ether, nonyl ethylene glycol monohexyl ether, and the like.

Examples of polyols having a normal boiling point of 280° C. or more, among the polyols, include, but are not particularly limited to, triethylene glycol, tetraethylene glycol, glycerin, and the like. The ink composition containing the polyol having a normal boiling point of 280° C. or more is hardly dried, and thus clogging recoverability tends to be more excellent.

Examples of polyols having a normal boiling point of less than 280° C. include, but are not particularly limited to, ethylene glycol, diethylene glycol, pentaethylene glycol, propylene glycol, dipropylene glycol, tripropylene glycol, 1,3-propanediol, 1, 2-butanediol, 1,2-pentanediol, 1,2-hexanediol, 1,4-butanediol, 1,5-pentanediol, 1, 6-hexanediol, and the like.

The content of the organic solvent relative to the total amount of the ink composition is preferably 18 by mass or more and 40% by mass or less, and more preferably 5.0% to 35.0% by mass, 10.0% to 30.0% by mass, or 15.0% to 25.0% by mass. When the content of the organic solvent is within the range described above, there is a tendency to more improve the clogging recoverability and more improve the ejection stability.

Also, the content of the polyol may be preferably within the range described above.

The content of the polyol having a normal boiling point of 280° C. or more relative to the total amount of the ink composition is preferably 5% to 25% by mass or 10% to 20% by mass. When the content of the polyol having a normal boiling point of 280° C. or more is within the range described above, the clogging recoverability tends to be more improved.

The content of the polyol having a normal boiling point of 280° C. or more relative to the total amount of the organic solvent is preferably 50% to 85% by mass or 60% to 80% by mass. When the content of the polyols having a normal boiling point of 280° C. or more is within the range described above, the clogging recoverability tends to be more improved.

### 1. 5. 2. Water

The ink composition of the present embodiment contains water as the solvent component. Examples of water include, but are not particularly limited to, ion exchange water, ultrafiltered water, reverse osmosis water, distilled water, and the like.

An ink of the present embodiment is an aqueous ink, and the aqueous ink is an ink composition containing a solvent component containing at least water as a principal component.

The content of water relative to the total amount of the ink composition is not particularly limited but, for example, 30.0% by mass or more, and preferably 30.0% to 99.0% by mass, 40.0% to 95.0% by mass, 50.0% to 95.0% by mass, 52.5% to 90% by mass, or 55.0% to 80% by mass.

### 1. 6. Betaine

The ink composition of the present embodiment preferably contains betaine. The “betaine” represents a compound which has positive charge and negative charge at non-adjacent positions in the same molecule, and in which dissociable hydrogen is not bonded to the atom having positive charge, forming an intramolecular salt without having charge as the whole molecule. The betaine of the present embodiment preferably has a quaternary ammonium cation as a positive charge site.

The ink composition containing the betaine prevents the ink composition from being dried in nozzles of an ink jet head. Therefore, the flying curve and non-ejection of the ink composition can be prevented, and the ejection stability tends to be improved. Also, the ink composition is hardly dried and maintains a wet state. Consequently, the clogging recoverability tends to be improved. In addition, the ink composition containing the betaine tends to suppress the curling of the resultant recorded matter.

Examples of the betaine include, but are not particularly limited to, trimethylglycine, γ-butyrobetaine, formalin, trigonelline, carnitine, homoserine betaine, valine betaine, lysine betaine, ornithine betaine, alanine betaine, stachydrine, glutamic acid betaine, and the like. Among these, any one of trimethylglycine, γ-butyrobetaine, and carnitine is preferably contained, and trimethylglycine is more preferably contained. This tends to more improve the clogging recoverability. The betaines may be used alone or in combination of two or more.

The content of the betaine relative to the total amount of the ink composition is preferably 1.0% to 10.0% by mass, 1.5% to 9.0% by mass, 2.0% to 8.0% by mass, or 2.5% to 7.5% by mass. With the betaine content of 1.0% by mass or more, the ejection stability tends to be excellent, and with the betaine content of 10.0% by mass or less, the phase separation of the acetylene glycol-based surfactant in the ink composition can be suppressed, and thus the clogging recoverability tends to be excellent.

### 1. 7. Other Components

The ink composition of the present embodiment may contain, besides the components described above, other known components which can be used in usual ink compositions. Examples of the other components include, but are not particularly limited to, a solubilizer, a viscosity modifier, a pH adjuster such as triethanolamine or the like, an antioxidant, a preservative, a corrosion inhibitor, a chelating agent for capturing predetermined metal ions affecting dispersion, other additives, an organic solvent other than the above, and the like. The other components may be used alone or in combination of two or more.

### 2. Method for Producing Ink Jet Ink Composition

The ink composition of the present embodiment may be produced by, but not particularly limited to, for example, mixing the components described above. Alternatively, a coloring material dispersion liquid is prepared by dispersing a coloring material and a dispersant in a solvent, and the resultant coloring material dispersion liquid may be mixed with the other components described above. The solvent used for dispersing the coloring material and the dispersant is not limited to water.

### 3. Recording Medium

Examples of a recording medium used for recording the ink composition of the present embodiment include, but are not particularly limited to, an absorptive recording medium, a low-absorptive recording medium, and a non-absorptive recording medium. The ink composition of the present embodiment is preferably used for recording on an absorptive recording medium.

Examples of the absorptive recording medium include, but are not particularly limited to, plain paper such as electrophotographic paper with high ink permeability and the like, ink jet paper (ink jet exclusive paper including an ink absorbing layer composed of silica particles or alumina particles, or an ink absorbing layer composed of a hydrophilic polymer, such as polyvinyl alcohol (PVA), polyvinyl pyrrolidone (PVP), or the like), fabric, and the like.

The absorptive recording medium is preferably paper such as plain paper, ink jet exclusive paper, or the like. In the absorptive recording medium, a portion which absorbs the ink composition without containing water preferably contains a calcium salt. In this case, the ink of the present embodiment preferably exhibits excellent color development. For example, the portion corresponds to the whole of the recording medium or the ink absorbing layer.

Examples of the calcium salt include a water-soluble calcium salt, a poorly water-soluble calcium salt, and the like. In view of enhancing the color development of the ink, a water-soluble calcium salt is preferred, but a poorly water-soluble calcium salt may be used. Examples of the poorly water-soluble calcium salt include calcium carbonate and the like. Examples of the water-soluble calcium salt include calcium chloride and the like.

Examples of the low-absorptive recording medium include, but are not particularly limited to, art paper, coated paper, cast paper, and the like, which have relatively low ink permeability and are used for general offset printing.

Examples of the non-absorptive recording medium include, but are not particularly limited to, films and plates of plastics such as polyvinyl chloride, polyethylene, polypropylene, polyethylene terephthalate (PET), polycarbonate, polystyrene, polyurethane, and the like; plates of metals such as iron, silver, copper, aluminum, and the like; metal plates and plastic films which are produced by vapor deposition of these metals, plates of alloys such as stainless, brass, and the like; a recording medium including a paper substrate and a film of plastic bonded (coated) thereon, using polyvinyl chloride, polyethylene, polypropylene, polyethylene terephthalate (PET), polycarbonate, polystyrene, polyurethane, or the like; and the like.

The “low-absorptive recording medium” or the “non-absorptive recording medium” represents a recording medium having an amount of water absorption of 10 mL/m² or less from the start of contact to 30 msec in a Bristow method, the “absorptive recording medium” represents a recording medium having an amount of water absorption of over 10 mL/m². The Bristow method is most popularized as a method for measuring a liquid absorption amount within a short time, and is used in “Japan Technical Association of the Pulp and Paper Industry” (JAPAN TAPPI). The details of the test method are described in “Standard No. 51-Paper and Paperboard-Liquid Absorption Test Method-Bristow method” of JAPAN TAPPI PAPER AND PULP TEST METHODS, 2000.

### 4. Recording Apparatus

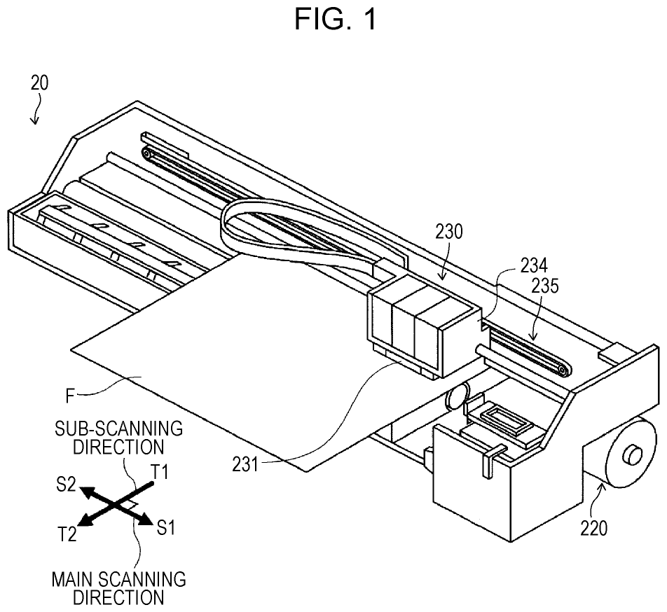

A recording apparatus of the present embodiment is an ink jet recording apparatus used in printing using the ink composition of the present embodiment. FIG. 1 shows a perspective view of a serial printer as an example of the ink jet recording apparatus. As shown in FIG. 1, a serial printer 20 includes a transport portion 220 and a recording portion 230. The transport portion 220 transports, to the recording portion 230, recording medium F fed to the serial printer and discharges the recording medium after recording to the outside of the serial printer. Specifically, the transport portion 220 has feed rollers and transports the recording medium F in the sub-scanning direction T2.

Also, the recording portion 230 includes an ink jet head 231 that ejects an ink or the like to the recording medium F fed from the transport portion 220, a carriage 234 mounted with the head, and a carriage moving mechanism 235 that moves the carriage 234 in the main scanning direction S1/S2 of the recording medium F.

The serial printer includes, as the ink jet head 231, a head having a length smaller than the width of the recording medium, and recording is performed by moving the head in a plurality of passes. Also, in the serial printer, the head 231 is mounted on the carriage 234 moved in the predetermined direction, and the ink composition is ejected on the recording medium F by movement of the head with the movement of the carriage. As a result, recording is performed in 2 or more passes. In addition, “pass” is also referred to as “main scanning”. Further, sub-scanning for transporting the recording medium is performed between the passes. That is, main scanning and sub-scanning are alternately performed.

In addition, the serial printer may be provided with a drying mechanism not shown. By providing the drying mechanism, the solvent or the like can be rapidly evaporated and scattered from the ink composition adhered to the recording medium, thereby rapidly forming a recorded image or the like. The drying mechanism is not particularly limited as long as it includes a mechanism for promoting evaporation and scattering of the solvent or the like contained in the ink composition. Examples thereof include a heating mechanism that applies heat to the recording medium, a blowing mechanism that blows the air to the ink composition, and a combination of these mechanisms. Examples of the drying mechanism include a forced-air heating device, a radiation heating device, a conduction heating device, a high-frequency heating device, and a microwave heating device.

Also, the ink jet apparatus of the present embodiment is not limited to the serial printer described above, but may be a line printer. The line printer is a printer performing recording on the recording medium by one time of scanning using a line head serving as an ink jet head having a length longer than the recording width of the recording medium.

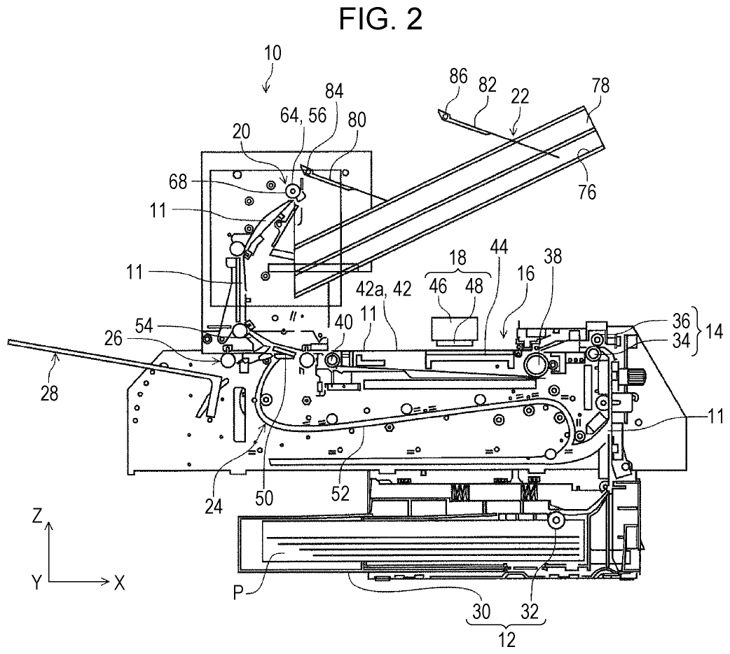

FIG. 2 is a drawing showing a line printer as an example of the ink jet recording apparatus.

In the X-Y-Z coordinate system shown in FIG. 2, the X direction indicates the length direction of the recording medium, the Y direction indicates the width direction of the recording medium in the transport path in the recording apparatus, and the Z direction indicates the height direction of the apparatus.

An example of a recording apparatus 10 is a line-type ink jet printer capable of printing at high speed and high density. The recording apparatus 10 includes a feed portion 12 that houses a recording medium P such as paper or the like, a transport portion 14, a belt transport portion 16, a recording portion 8, a Fd (face down) discharge portion 20 as a discharge portion, a Fd (face down) mounting portion 22 as a mounting portion, a reversing path portion 24 as a reversing transport mechanism, a Fu (face up) discharge portion 26, and a Fu (face up) mounting portion 28.

The feed portion 12 is disposed in a lower portion of the recording apparatus 10. The feed portion 12 includes a feed tray 30 that houses the recording medium P, and a feed roller 32 that sends the recording medium P housed in the feed tray 30 to the transport path 11.

The recording medium P housed in the feed tray 30 is fed by the feed roller 32 to the transport portion 14 along the transport path 11. The transport portion 14 includes a transport drive roller 34 and a transport driven roller 36. The transport drive roller 34 is rotationally driven by a drive source not shown. In the transport portion 14, the recording medium P is pinched (nip) between the transport drive roller 34 and the transport driven roller 36 and transported to the belt transport portion 16 located downstream of the transport path 11.

The belt transport portion 16 includes a first roller 38 located upstream in the transport path 11, a second roller 40 located downstream, an endless belt 42 provided on the first roller 38 and the second roller 40 to be rotationally movable, and a support member 44 that supports the upper side region 42a of the endless belt 42 between the first roller 38 and the second roller 40.

The endless belt 42 is driven by the first roller 38 or the second roller 40, which is driven by a drive source not shown, so as to be moved from the +X direction to the −X direction in the upper side region 42a. Therefore, the recording medium P transported from the transport portion 14 is further transported to downstream in the transport path 11 by the belt transport portion 16.

The recording portion 8 includes a line-type ink jet head 48 and a heed holder 46 that holds the ink jet head 48. The ink jet head 48 is disposed so as to face the upper side region 42a of the endless belt 42 supported by the support member 44. In addition, nozzles not shown are disposed in line in the Y direction in a lower portion of the ink jet head 48.

When the recording medium P is transported, the ink jet head 48 performs recording by ejecting the ink to the recording medium P in the upper side region 42a of the endless belt 42. During recording, the recording medium P is transported to downstream in the transport path 11 by the belt transport portion 16.

A first branch portion 50 is provided downstream of the belt transport portion 16 in the transport path 11. The first branch portion 50 is configured to be switchable between the transport path 11 in which the recording medium P is transported to the Fd discharge portion 20 or the Fu discharge portion 26 and the reversing path 52 of the reversing path portion 24 in which the recording surface of the recording medium P is reversed, and the recording medium P again transported to the recording portion 8. In the recording medium P switched to the reversing path 52 by the first branch portion 50 and transported, the recording surface is reversed in the transport process in the reversing path 52, and the recording medium P is again transported to the recording portion 8 so that the surface opposite to the first recording surface faces the ink jet head 48.

Further, a second branch portion 54 is provided downstream of the first branch portion 50 along the transport path 11. The second branch portion 54 is configured so that the transport direction of the recording medium P can be switched to transport the recording medium P to the Fd discharge portion 20 or transport the recording medium P to the Fu discharge portion 26.

The recording medium P transported to the Fd discharge portion 20 in the second branch portion 54 is discharged from the Fd discharge portion 20 and mounted in the Fd mounting portion 22. In this case, the recording medium P is mounted so that the recording surface thereof faces the Fd mounting portion 22. Also, the recording medium P transported to the Fu discharge portion 26 in the second branch portion 54 is discharged from the Fu discharge portion 26 and mounted in the Fu mounting portion 28. In this case, the recording medium P is mounted so that the recording surface thereof faces opposite to the Fu mounting portion 28.

In addition, the line-type ink jet head (line head) is a head used in a recording apparatus in which a region, where nozzles are formed in the direction intersecting the transport direction of the recording medium M, is provided so that the whole of the recording region in the direction intersecting the recording medium M can be covered, and one of the head and the recording medium M is fixed, while the other is moved, forming an image. The nozzle region in the intersecting direction of the line head may not cover the whole of the intersecting direction of the whole of the recording medium M treated with the recording apparatus.

The line printer performs recording in one pass (single pass) using the head which is fixed without being moved, and is thus more useful than the serial printer with respect to the high recording speed.

### 5. Ink Jet Recording Method

An ink jet recording method of the present embodiment includes ejecting and adhering the ink composition of the present embodiment from an ink jet head to a recording medium. If required, the method may include other processes such as transporting the recording medium and the like.

### 5. 1. Ink Adhesion

In adhering the ink, the ink composition of the present embodiment is ejected from the ink jet head and adhered to the recording medium. More specifically, a pressure-generating unit provided in the ink jet head is driven to eject, from nozzles, the ink composition filled in a pressure generating chamber of the ink jet head.

Examples of the ink jet head used for adhering the ink include a line head performing recording in a line system, and a serial head performing recording in a serial system. From the viewpoint of increasing the recording speed, the ink jet head is preferably a line head.

In the line system using the line head, for example, the ink jet head having a width larger than the recording width of the recording medium is fixed to the recording apparatus. The recording medium is moved along the sub-scanning direction (transport direction of the recording medium), and ink droplets are ejected from the nozzles of the ink jet head in conjugation with the movement, thereby recording an image on the recording medium.

In the serial system using the serial head, for example, the ink jet head is mounted on a carriage movable in the width direction of the recording medium. The carriage is moved along the main scanning direction (width direction of the recording medium), and ink droplets are ejected from the nozzles of the ink jet head in conjugation with the movement, thereby recording an image on the recording medium.

### 5. 2. Transport

The ink jet recording method using the ink composition of the present embodiment may include transport. In transport, the recording medium is transported in the predetermined direction in the recording apparatus. More specifically, in the recording apparatus, the recording medium is transported from a feed portion to a discharge portion using a transport roller and a transport belt provided in the recording apparatus. In transporting, the ink composition ejected from the ink jet head is adhered to the recording medium, forming a recorded matter. The ink adhesion and transport may be performed simultaneously or alternately.

Double-sided printing includes inverting the recording medium while transporting it between recording on one of the surfaces of the recording medium and recording on the other surface.

In double-sided printing, the recording speed is preferably 10 sheets/min or more, more preferably 15 sheets/min or more, and still more preferably 20 sheets/min or more. The upper limit of the recording speed is not particularly limited, but is preferably 50 sheets/min or less and more preferably 40 sheets/min or less.

In double-sided printing, one sheet has two pages. Thus, in terms of the number of pages, sheets/min becomes two times of pages/min. The recording speed may be represented by “number of pages/min”.

At the recording speed within or higher than the range described above, a short time is taken to transport using the transport rollers after ink adhesion. In addition, when recording media recorded at such a recording speed are discharged and stacked in the paper discharge portion of the recording apparatus, the recording media have many opportunities that the recording medium surfaces come into contact with each other before the ink composition is permeated and dried, and thus the effect of the present discloser becomes more effective.

Recording may be performed by single-sided printing. In single-sided printing, one sheet has one page, and thus the recording speed is represented by “number of pages/min”. In the single-sided printing, the recording speed within the range described above is preferred.

Also, in single-sided printing, the recording surface of one of the stacked recorded matters may be brought into contact with the back surface of another recorded matter, causing ink transfer contamination. However, the present embodiment can preferably decrease ink transfer contamination.

### EXAMPLES

The present disclosure is more specifically described below by using examples and comparative examples. The present disclosure is not limited to examples below. In addition, experiments in the example and comparative examples are performed at room temperature (25° C.) and 1 atom unless otherwise specified.

### 1. Preparation of Ink Jet Ink Composition

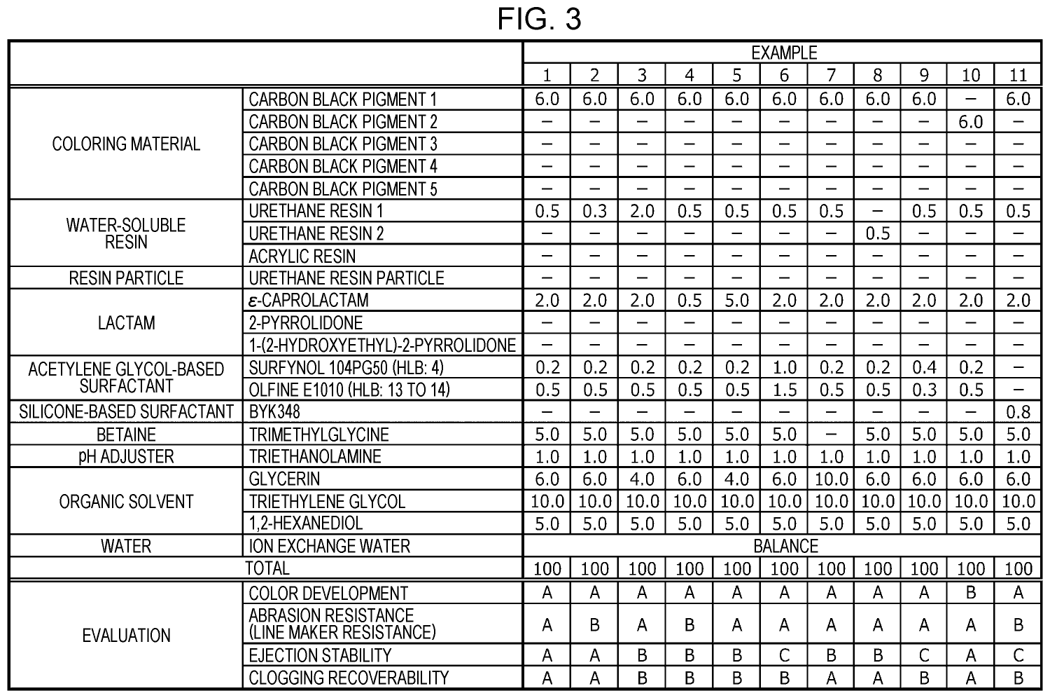

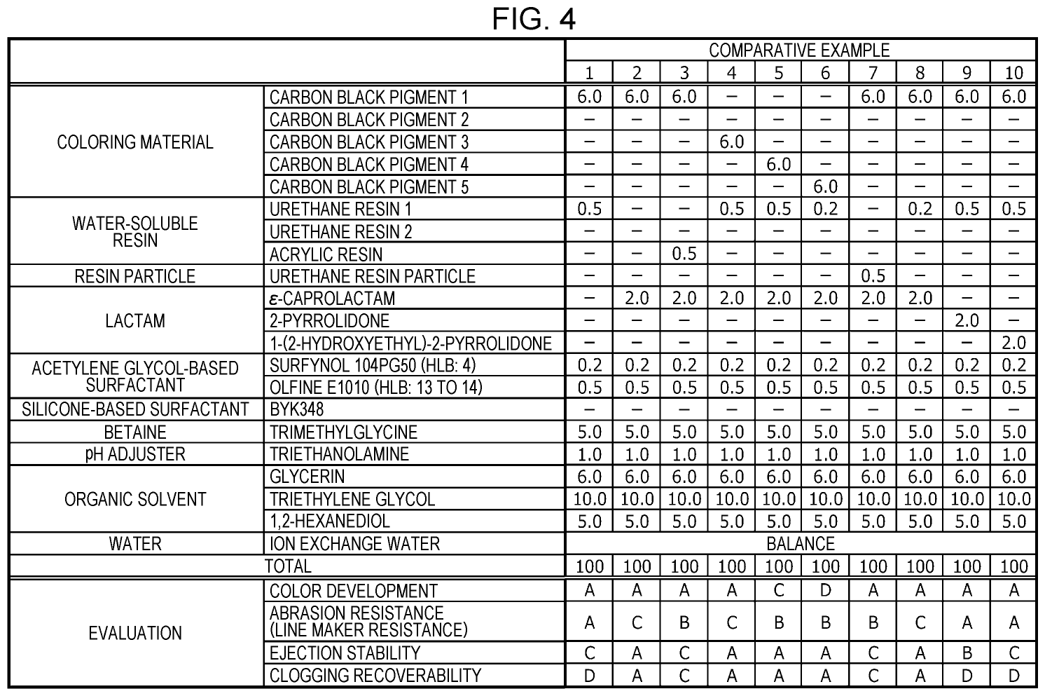

Components are added to a mixture tank serving as a stainless-made container to provide the compositions described in the tables of FIGS. 3 and 4 and mixed and stirred at room temperature, and then, if required, impurities and foreign materials are removed by filtration or the like, preparing an ink jet ink composition used in each of the examples. In the drawings, the numerical value of each of the components shown in the examples represents “% by mass” unless otherwise specified. The “% by mass” of a coloring material, a water-soluble resin, and resin particles represents the solid content concentration. The components in the tables indicate the following. With respect to the pigment, a pigment dispersion liquid is prepared as described below and used for preparing an ink.
Surfynol 104PG50 (manufactured by Air Products, Inc.)
Olfine E1010 (manufactured by Nissin Chemical Industry Co., Ltd.)
BYK 348 (manufactured by BYK Chemie Japan K. K.)
Urethane resin particles (Super Flex 420 (product name), manufactured by DKS Co. Ltd.)

### Carbon Black Pigment 1

The carbon black pigment 1 in the drawings is produced by the following method.

First, 500 g of carbon black base powder prepared by a furnace method is added to 3750 g of ion exchange water, and heated to 50° C. under stirring by a dissolver. Then, 5300 g of an aqueous solution of sodium hypochlorite (effective chlorine concentration=12%) is dropped in the resultant mixture at 50° C. to 60° C. over 3.5 hours while the mixture is ground by a sand mill using zirconia beads having a diameter of 0.8 mm. Then, grinding with the sand mill is continued for 30 minutes, preparing a reaction solution. The resultant reaction solution is filtered with a wire net of 400 mesh to separate the zirconia beads and unreacted carbon black from the reaction solution. Then, a 5% aqueous solution of potassium hydroxide is added to the reaction solution obtained by separation to adjust to pH=7.5. Then, desalting and purification are performed using an ultrafiltration membrane until the electric conductivity of the solution is 1.5 mS/cm. Desalting and purification are further performed until the electric conductivity of the solution measured by an electrodialysis apparatus is 1.0 mS/cm. The solution is concentrated to a carbon black concentration of 17% by mass. The resultant concentrated solution is applied to a centrifugal separator to remove course particles, and filtered with a 0.6 μm filter. Then, ion exchange water is added the resultant filtrate, diluted to a carbon black concentration of 15% by mass, and then dispersed, obtaining the carbon black pigment 1. The carbon black pigment 1 is a self-dispersing pigment in which carbon atoms on the surfaces of pigment particles are converted to carboxyl groups by oxidation.

### Carbon Black Pigment 2

The carbon black pigment 2 in the drawings is produced by the following method.

A solution prepared by dissolving 5.0 g of concentrate hydrochloric acid in 5.5 g of water is cooled to 5° C., and 1.5 g of 4-amino-1, 2-benzene dicarboxylic acid (treating agent) is added to the solution. A vessel containing the solution is placed in an ice bath and cooled to 10° C. or less, and a solution prepared by dissolving 1.8 g of sodium nitride in 9 g of water of 5° C. is added. After stirring for 15 minutes, 6.0 g of carbon black pigment is added under stirring, and the resultant mixture is further stirred for 15 minutes, producing a slurry. The resultant slurry is filtered with filter paper (product name “Standard filter paper No. 2”, manufactured by Advantech Co., Ltd.), and the resultant particles are sufficiently washed with water. The water-washed particles are dried by an oven of 110° C., producing a self-dispersing pigment. Then, water is added to the resultant self-dispersing pigment so that the content of the pigment is 10.0% by mass, preparing a dispersion liquid. Then, the sodium ions in the dispersion liquid are ion-exchanged to potassium ions by an ion exchange method, producing the carbon black pigment 2 having —C₆H₃—(COOK)₂ groups bonded to the surfaces of pigment particles. The carbon black pigment 2 is in a state of being dispersed in in water. The carbon black pigment 2 is a self-dispersing pigment having a carboxyl group-containing compound introduced into the surfaces of pigment particles. Carbon black pigment 3

The carbon black pigment 3 in the drawings is produced by the following method.

First, [2-(4-aminophenyl)-1-hydorxyethane-1,1-diyl] bisphosphonic acid sodium salt is produced according to procedures below. A condenser having a gas output provided at the top thereof, a thermometer, a dry nitrogen input, and a 100 mL pressure equalizing addition funnel are attached to a 500 mL three-neck flask. In the flask, first 32 g of phosphorous acid (380 mmol) and 160 mL of methane sulfonic acid (solvent) are added. Then, 57.4 g of aminophenylacetic acid (380 mmol) is gradually added to the stirred mixture. The resultant stirred mixture is heated at 65° C. for 1 to 2 hours, completely dissolving the solid content. The whole of the system is flashed with dry nitrogen, and after the solid content is completely dissolved, the temperature is decreased to 40° C. Then, 70 mL of PCl₃ (800 mmol) is slowly added to the heated solution through the addition funnel. HCl gas is generated by reaction, and the gas is flowed to a drying tube through the gas outlet and then flowed to the concentrate NaOH solution in a beaker through the funnel. After the addition is completed, the reaction mixture is stirred for 2 hours and then heated at 40° C. After this time, the temperature is increased to 65° C. to 70° C., and the mixture is stirred overnight. The resultant clear brown solution is cooled to room temperature and quenched by adding to 600 g of an ice/water mixture. The aqueous mixture is added to a 1 L beaker and heated at 90° C. to 95° C. for 4 hours (the top of the beaker can be covered with a glass plate). Then, the mixture is cooled to room temperature, and the mixture is adjusted to pH 4 to 5 with a 50% NaOH solution (the NaOH solution is slowly added because the quenching results in an increase in temperature). The resultant mixture is cool at 5° C. for 2 hours using an ice bath, and then the produced solid content is collected by suction filtration, water-washed with 1 L of cooled deionized water and dried at 60° C. overnight, producing a white or off-white color solid product (yield: 48 g, 39%). Consequently, [2-(4-aminophenyl)-1-hydroxyethane-1,1-diyl] bisphosphonic acid sodium salt is obtained.

Next, 20 g of carbon black pigment, 20 mmol of the compound obtained as described above, and 20 mmol of nitric acid are added to 200 ml of deionized water, and stirred at 6000 rpm for 30 minutes. Next, 20 mmol of sodium nitrite is slowly added the resultant mixture. The mixture is stirred for 1 hour as described above. Then, the mixture is adjusted to pH 10 with NaOH. Thirty minutes after, the produced modified pigment is filtered with deionized water to produce a pigment dispersion liquid containing the carbon black pigment 3 dispersed therein. The resultant pigment dispersion liquid is adjusted to a pigment sold content of 12% by mass. The carbon black pigment 3 is a self-dispersing pigment containing a phosphonic acid group intruded therein.

### Carbon Black Pigment 4

Cab-o-Jet 200 (manufactured by Cabot Corporation) is used as the carbon black pigment 4 in the drawings. The carbon black pigment 4 is a self-dispersing pigment containing a sulfonic acid group intruded therein.

### Carbon Black Pigment 5

First, 3.0 g of a styrene-acrylic acid-based polymer dispersant (manufactured by BASF Japan Ltd., Joncryl 682) and 1.8 g of triethanolamine are dissolved in 80.1 g of ion exchange water, and 15 g of carbon black and 0.1 g of a defoaming agent (manufactured by Nissin Chemical Industry Co., Ltd., Surfynol DF110D) are added to the resultant solution, and dispersed by a paint shaker using zirconia beads, producing a dispersion liquid containing the carbon black pigment 5 dispersed therein.

The carbon black pigments 1 to 4 are self-dispersing pigments, while the carbon black pigment 5 is a resin-dispersed pigment. The volume-average particle diameter (D50) of any one of the carbon black pigments is 110 to 130 nm.

### Urethane Resin 1

Urethane resin 1 is prepared by the following method. A four-neck flask provided with a stirrer, a thermometer, a nitrogen gas inlet tube, and a reflux tube is prepared. In the four-neck flask, 41.7 parts by mass of isophorone diisocyanate, 40.1 parts by mass of polypropylene glycol (number-average molecular weight: 2000), 13.2 parts by mass of dimethylol propionic acid, and 200.0 parts by mass of methyl ethyl ketone are added and reacted (first-order reaction) at 80° C. for 6 hours in a nitrogen gas atmosphere. Next, 0.6 parts by mass of ethylene diamine, 2.0 parts by mass of methanol, 2.4 parts by mass of dimethylol propionic acid, and 100.0 parts by mass of methyl ethyl ketone are added. The residual rate f isocyanate group is confirmed by FT-IR, and the mixture is reacted (second-order reaction) at 80° C. until a desired residual rate is obtained, preparing a reaction solution. The resultant reaction solution is cooled to 40° C., ion exchange water is added, and then an aqueous potassium hydroxide solution is added under stirring at high speed using a homomixer. Then, methyl ethyl ketone is distilled off from the resultant liquid by heating pressure reduction, producing a liquid containing urethane resin 1.

With respect to the resultant urethane resin 1, the urethane resin is precipitated by adding hydrochloric acid to the liquid containing the urethane resin 1, and then the resin is vacuum-dried overnight at 40° C. and then dissolved in tetrahydrofuran, preparing a sample. When the acid value of the urethane resin 1 is measured by potentiometric titration using a potassium hydroxide-methanol titration solution, the acid value is 65 mgKOH/g. In addition, with respect to the resultant urethane resin 1, the weight-average molecular weight of the urethane resin measured in terms of polystyrene by gel permeation chromatography (GPC) is about 21000.

### Urethane Resin 2

Urethane resin 2 is prepared by the same preparation method as for the urethane resin 1 except that in preparing the urethane resin 1, the amount of polypropylene glycol added is decreased, and the amount of dimethylol propionic acid added in the first-order reaction and second-order reaction is increased. In addition, as a result of measurement of the acid value and weight-average molecular weight by the same measurement method as for the urethane resin 1, the acid value of the urethane resin 2 is 75 mgKOH/g, and the weight-average molecular weight is about 21000.

### Acrylic Resin

An acrylic resin is prepared by the following method. A four-neck flask provided with a stirrer, a thermometer, a reflux condenser, and a nitrogen gas inlet tube is prepared. In the four-neck flask, 200.0 parts by mass of ethylene glycol monobutyl ether is added, stirred in a nitrogen gas atmosphere, and heated to 130° C. Then, 62.0 parts by mass of styrene monomer, 22.0 parts by mass of butyl acrylate, 16.0 parts by mass of acrylic acid, and 4.0 parts by mass of a polymerization initiator (tert-butyl peroxide) are dropped over 3 hours. After aging for 2 hours, the ethylene glycol monobutyl ether is distilled off under reduced pressure, producing an acrylic resin.

### 2. Evaluation Method

An apparatus used as a recording apparatus for evaluation below is produced by modifying, to a line ink jet printer provided with a line head, PX-S270T (product name, manufactured by Seiko Epson Corporation), which is an ink jet printer having a double-sided printing mechanism. The configuration is as shown in FIG. 2.

### 2. 1. Color Development

Paper used as recording media are “Xerox P paper” (also referred to as “XP paper”, manufactured by Fuji Xerox Corp., basis weight: 64 g/m²) and “Copyplus paper” (also referred to as “CO paper”, manufactured by Hammermill Paper Company, basis weight: 75 g/m²). The ink of each of the examples is filled in the recording apparatus described above, and a solid pattern is recorded so that the adhesion amount of the ink composition of each of the examples is 6 mg/inch². Then, the OD value (optical density) is measured by using ilPro2 (manufactured by X-Rite, Inc.) and evaluated according criteria below. The CO paper contains a calcium salt at a higher content than that in the XP paper and tends to have higher color development.

### [Evaluation Criteria]

A: The OD values of both recording media are 1.3 or more.
B: The OD value of one of the recording media is 1.3 or more, and the OD value of the other recording medium is less than 1.3.
C: The OD values of both recording media are less than 1.3.
D: The OD values of both recording media are less than 1.3, and the OD value of at least one of the recording media is 1.1 or less.

### 2.2. Abrasion Resistance (Line-Marker Resistance)

The same recording media as in the color development test are used, and a character line pattern with a size of 55 pt is recorded on the recording media using the ink composition of each of the examples. Immediately after recording, the recording media are fixed to a flat surface, which is horizontally installed, and 1 hour after the recording, the character line is rubbed with a line market “OPTEX CARE” (manufactured by Zebra Co., Ltd.). Then, the recording media are evaluated by visual observation according to criteria below. When the evaluations of the recording media are different, the lower evaluation is used. For example, when the Xerox P paper corresponds to evaluation B, and the Copyplus paper corresponds to evaluation C, the ink composition of the example or comparative example is evaluated as “C”.

### [Evaluation Criteria]

A: Color blurring of characters does not occur even by two times of rubbing.
B: Color blurring of characters does not occur even by one time of rubbing, but color blurring of characters occurs by two times of rubbing.
C: Color blurring of characters occurs by one time of rubbing.

Also, double-sided printing is continuously performed on 50 sheets of paper using the ink composition of each of the examples and the recording apparatus and recording media described above, and the obtained recorded matters are discharged to a discharge tray in order from the recorded matter for which printing is finished. The recording speed is 15 sheets/min.

Then, whether or not ink transfer contamination occurs due to rollers during transport is visually observed at the end surface in the recording medium transport direction of the stack of the recorded matters stacked in the discharge tray. As a result, when the ink composition evaluated as “C” of the evaluation criteria is used, contamination of the end surface is noticeable, while when the ink composition evaluated as “B” or “A” is used, contamination on the end surface is not observed or is unnoticeable.

It is found that the ink hardly causing transfer contamination hardly causes ink peeling by rugging. Further, the recording by the same double-sided printing as described above at a recording speed of 20 sheets/min tends to increase ink transfer contamination.

### 2. 3. Ejection Stability

It is confirmed that the ink jet head of the recording apparatus described above has nozzles in a normal ejection state, and then the ink composition of each of the examples is filled in the ink jet head, and a test pattern is printed on a recording medium. Then, after idling of the ink jet head for 5 minutes in a state of being filled with the ink composition of each of the examples, the test pattern is again printed, and the number of nozzles having an ink landing position deviation is confirmed. In this case, when an ink landing position deviation of 50% or more relative to the distance between adjacent nozzles is observed, the landing position deviation is specified as occurring and evaluated according to criteria below.

### [Evaluation Criteria]

A: There is no nozzle causing landing position deviation.
B: The number nozzles causing landing position deviation is 1% or less relative to the total number of nozzles.
C: The number of nozzles causing landing position deviation is over 1% and 3% or less relative to the total number of nozzles.
D: The number nozzles causing landing position deviation is over 3% relative to the total number of nozzles.

### 2. 4. Clogging Recoverability

After it is confirmed that the ink jet head of the recording apparatus described above does not have a non-ejection nozzle which cannot eject the ink composition, the head is allowed to stand at 40° C. for 1 day in the state of being not capped. Then, 0.5 cc of the ink is sucked from the nozzles using one head (600 nozzles) of the line head, and the nozzle surface is wiped (cleaned) with a rubber wiper. The number of times of cleaning performed until the non-ejection nozzle is not found is measured and evaluated according to criteria below.

### [Evaluation Criteria]

A: The non-ejection nozzle is not found by three times or less of cleaning.
B: The non-ejection nozzle is not found by four or five times of cleaning.
C: The non-ejection nozzle is not found by six times of cleaning.
D: The non-ejection nozzle is found even by six times of cleaning.

The evaluation results indicate that the ink of the present embodiment, which contains the self-dispersing pigment having a carboxyl group intruded therein, the lactam having a 6- to 8-membered lactam ring, the solvent component containing water, and 0.38 by mass or more of the water-soluble urethane resin dissolved in the solvent component, which is 0.3% by mass or more relative to the total amount of the ink composition, is excellent in all of color development, abrasion resistance, and clogging recoverability, and further excellent in ejection stability.

On the other hand, the ink not according to the present embodiment is poor in terms of one of color development, abrasion resistance, and clogging recoverability.

What is claimed is:

1. An ink jet ink composition comprising:
a pigment;
a lactam having a 6- to 8-membered lactam ring;
a solvent component; and
a water-soluble urethane resin dissolved in the solvent component, wherein
the pigment contains a self-dispersing pigment having a carboxyl group introduced therein;
the content of the water-soluble urethane resin is 0.3% by mass or more relative to the total amount of the ink jet ink composition;
the solvent component contains water; and
the ink jet ink composition is an aqueous ink.

2. The ink jet ink composition according to claim 1, wherein the content of the water-soluble urethane resin is 0.3% to 3.0% by mass relative to the total amount of the ink jet ink composition.

3. The ink jet ink composition according to claim 1, wherein the content of the lactam is 0.5% to 5.08 by mass relative to the total amount of the ink jet ink composition.

4. The ink jet ink composition according to claim 1, further comprising an acetylene glycol-based surfactant.

5. The ink jet ink composition according to claim 4, wherein the HLB value of the acetylene glycol-based surfactant is 6 or less.

6. The ink jet ink composition according to claim 4, wherein the content of the acetylene glycol-based surfactant is 0.2% to 2.0% by mass relative to the total amount of the ink jet ink composition.

7. The ink jet ink composition according to claim 1, wherein the content of the self-dispersing pigment having a carboxyl group introduced therein is 38 to 12% by mass relative to the total amount of the ink jet ink composition.

8. The ink jet ink composition according to claim 1, wherein the acid value of the water-soluble urethane resin is 40 to 80 mgKOH/g.

9. The ink jet ink composition according to claim 1, further comprising betaine.

10. The ink jet ink composition according to claim 1, wherein the ink jet ink composition is used for recording on an absorptive recording medium.

11. An ink jet recording method comprising:
ejecting and adhering the ink jet ink composition according to claim 1 from an ink jet head to a recording medium.

12. The ink jet recording method according to claim 11, wherein the ink jet head is a line head.
